(19) United States
(12) Patent Application Publication
(10) Pub. No.: US 2009/0228794 A1
(43) Pub. Date: Sep. 10, 2009

(54) BUSINESS SPECIFICATION COMPREHENSION ASSISTANCE SYSTEM AND METHOD

(76) Inventors: Hitomi HASEGAWA, Yokohama (JP); Kazuyuki Aoyama, Akishima (JP)

Correspondence Address: MATTINGLY & MALUR, P.C., 1800 DIAGONAL ROAD, SUITE 370, ALEXANDRIA, VA, 22314, US

(21) Appl. No.: 12/265,789

(22) Filed: Nov. 6, 2008

(30) Foreign Application Priority Data
Nov. 7, 2007 (JP) 2007-289151

(51) Int. Cl. G06F 3/00

(52) U.S. Cl. 715/705

(57) ABSTRACT

A business specification is extracted so as to be represented by performing an analysis in a data item level by employing information which can be readily defined by a person who inputs business knowledge. While business functions and interfaces such as a series of screens corresponding to the business functions are employed as inputs, such a data item is extracted which is updated by employing an interface analysis and a program analysis. If a data item required for producing data which is updated in one business function is not inputted within this business function, the data item is defined as a preconditional condition item so as to be specified. If it is required that a business function for updating the preconditional condition item prior to the business function has been processed, a dependent relationship established between two pieces of the above-explained business is extracted so as to be represented.

### INCORPORATION BY REFERENCE

The present application claims priority from Japanese application JP2007-289151 filed on Nov. 7, 2007, the content of which is hereby incorporated by reference into this application.

### BACKGROUND OF THE INVENTION

The present invention is related to reverse engineering assistance which analyzes an interface being used in an information system and a program for executing process operations thereof so as to assist comprehension of the program.

Conventionally, reverse engineering techniques for extracting information related to specifications of systems from system information of programs and the like have been widely utilized. However, only based upon the system specifications extracted from the programs, it is impossible to recover such specifications from which business functions can be comprehended. As a consequence, such a system has been proposed in US 2006/224555 (prior art 1). That is, a set having a business functional meaning which constitutes a program is extracted, and the meaning is added to the extracted set. In this system, correspondence between a business function and input/output logic data, correspondence between the business function and a program, and correspondence between logic data and physical data are entered by a user, and these entered correspondence data are combined with an analysis result of reverse engineering in order to give business implication to extracted elements of an information system.

Also, another technique has been proposed in JP-A-04-169968 (prior art 2). In this technique, while an attention is paid not to the system information such as the program, but to slips which have been actually utilized in business functions, this conventional technical idea automatically produces processing specifications as to clerical work business functions in which slips having a plurality of different data structures have been mixed with each other from formats of these slips. In this system, while the format of the slip data group is inputted, since these formats are combined with the business dictionary and the business knowledge base, which have been previously prepared, this system has produced the business processing specification in accordance with the data structures which have been matched with each other.

### SUMMARY OF THE INVENTION

When a business specification is extracted from an information system, for instance, business knowledge must be applied to the information system in such a format as, for example, a dictionary. However, any persons having the business knowledge do not always have deep knowledge with respect to programs, structures of information systems, and data structures. Accordingly, there is a certain limitation that the business knowledge is caused to be inputted in such a form that these programs, system structures, and data structures are directly coupled to the business knowledge. For example, there are many possibilities that when a person who actually performs business by employing an information system processes a certain business function, this person never executes the business by considering these factors that which program is running, which data is accessed, and which data has been updated, but the person performs the business by paying her attentions only to necessary inputs for processing business functions.

Also, more specifically, in an online system, there are many possibilities that a plurality of application programs update the same database. When a business specification is extracted from such an online system, information which is processed in each of business functions must be analyzed not in the unit of the data base, but in the unit of a data item.

A problem that is to be solved by the present invent is given as follows: That is, in addition to presently available system information such as programs, since an analysis is carried out in a data item level by employing information which can be readily defined by a person having business knowledge, such a business comprehensive specification can be extracted.

In the present invention, while business functions and an interface such as a series of screens corresponding to the business functions are employed as inputs, since the information of the presently available system is analyzed, both a data item to be updated in this business function and a data item to be accessed are extracted. It should be understood that a business function implies such a series of operations which are executed by one user in order to achieve a certain business purpose.

In this case, the correspondence between the business functions entered from the user and the interfaces is merely equal to the correspondence between the information system and an external source, the correspondence between the program for constituting the information system and the business function cannot be indicated only by the above-described correspondence.

As a consequence, in accordance with the present invention, a business specification is extracted and the extracted business specification is represented by performing an analysis in a data item level by employing information which can be readily defined by a person who inputs business knowledge.

Concretely speaking, as one embodiment mode, the below-mentioned technical idea is contained: That is, while business functions and interfaces such as a series of screens corresponding to the business functions are employed as inputs, such a data item is extracted which is updated in the business by employing an interface analysis and a program analysis. In such a case that a data item required for producing data which is updated in one business function is not inputted within this business function, the above-described data item is defined as a preconditional condition item so as to be specified. In such a case that it is required that a business function for updating the preconditional condition item prior to the above-described business function has been processed, a dependent relationship established between two pieces of the above-explained business is extracted so as to be represented.

In addition, in the present invention, the following modes are also included: That is, an interface itself corresponding to a business function designated by the user is analyzed so as to acquire a program corresponding to input/output data items.

New, the program is analyzed so as to acquire the input/output data items corresponding to the program, and a database corresponding to the data items.

The results acquired from the respective process operations are employed in order to extract such a condition that a data item to be updated in one business function and a data item which is required for producing this data item have been inputted from which interface.

Based upon the above-described information, although the extracted data item is such a data item which is required in order to produce the data to be updated in one business function, such a data item which is not inputted within this business function is specified. The specified data item will be referred to as a preconditional condition item. In such a case that the preconditional condition item is present in a certain business function, it is required that a business function for updating the preconditional condition item has been processed prior to such a process operation for processing this business function. A relationship established between such two business functions will be referred to as a dependent relationship.

A dependent relationship established between two business functions is acquired by judging whether or not such a data item judged as the preconditional condition item is updated in which business function with respect to a certain business function based upon the previously obtained analysis results.

Since the dependent relationship acquired in the above-described manner is represented with respect to the user, the business specification extracted from the information system can be provided with respect to the user in an easily comprehendible form. As a consequence, in accordance with the present invention, comprehension of the business system can be assisted with respect to the user.

Other objects, teachers and advantage of the invention will become apparent from the following description of the embodiments of the invention taken in conjunction with the accompanying drawings.

### BRIEF DESCRIPTION OF THE DRAWINGS

FIG. 1 is a functional flow diagram for showing an outline of entire process operations of an embodiment of the present invention.

FIG. 2 is a system outline diagram of the embodiment of the present invention.

FIG. 3 is an entire diagram of a process flow according to the embodiment of the present invention.

FIG. 4 represents a user input image diagram when a business function I/table.

FIG. 5 is a process flow chart in an I/F analysis.

FIG. 6 is a process flow chart in a program analysis.

FIG. 7 is a process flow chart in an input starting point seeking operation.

FIG. 8 is a detailed process flow chart of the input starting point seeking operation.

FIG. 9 is a process flow chart in a preconditional business function analysis.

FIG. 10 is a diagram for indicating a business function I/F table which shows correspondence between business functions and I/Fs.

FIG. 11 is a diagram for representing an analysis business function table which stores thereinto business functions to be analyzed.

FIG. 12 is a diagram for indicating an analysis I/F table which stores thereinto I/Fs to be analyzed.

FIG. 13 is a diagram for an I/F table which stores thereinto results of the I/F analysises.

FIG. 14 is a diagram for indicating an analysis program table which stores thereinto programs to be analyzed.

FIG. 15 is a diagram for indicating a program table which stores thereinto results of program analysises.

FIG. 16 is a diagram for showing an analysis data table which stores thereinto data to be analyzed.

FIG. 17 is a diagram for showing a business function table which stores therein results of business function analyses.

FIG. 18 is a diagram for indicating an analysis preconditional item table which stores thereinto business functions and preconditional items thereof.

FIG. 19 is a diagram for representing an updating item table which stores thereinto business functions and DB updating items thereof.

FIG. 20 is a diagram for representing a preconditional business function table which stores thereinto results of the preconditional business function analysis.

FIG. 21 is a diagram for representing an output screen of the system according to the embodiment of the present invention.

FIG. 22 is an outline diagram of hardware of an apparatus according to the embodiment of the present invention.

### DESCRIPTION OF THE EMBODIMENTS

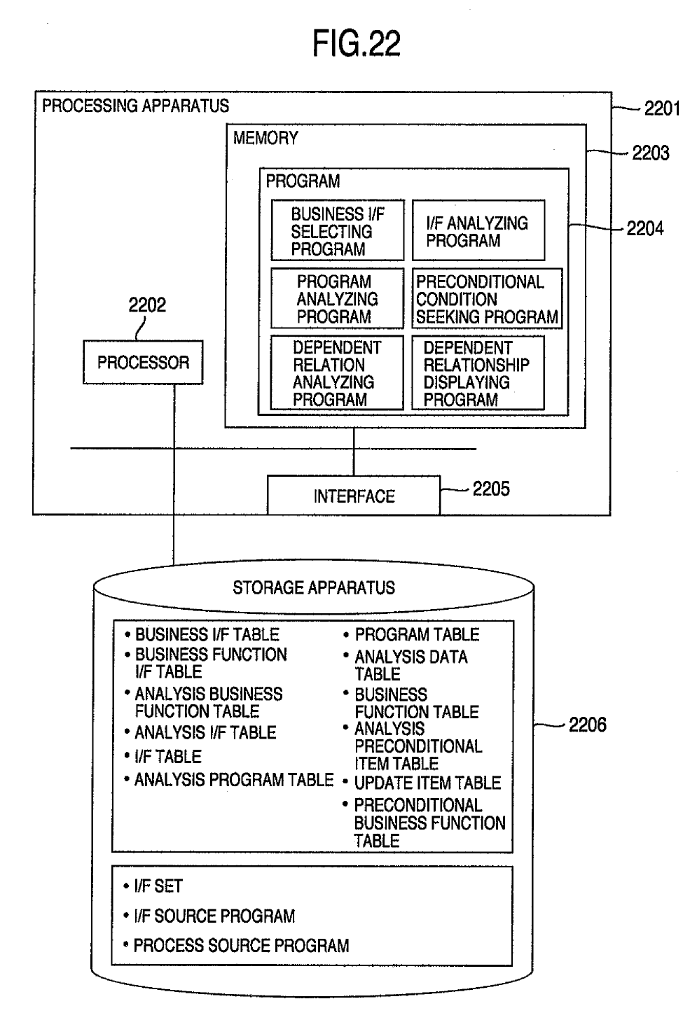

Referring now to drawings, a description is made of an embodiment mode of the present invention. FIG. 22 is an example of a diagram for showing a hardware structure of a system for realizing the present embodiment. A processing apparatus 2201 contains a processor 2202, a memory 2203, and an interface 2205 (will be referred to as “I/F” hereinafter). Also, a storage apparatus 2206 such as a hard disk drive and the like has been connected to the above-described system.

Since various sorts of programs 2204 stored in the memory 2203 are executed by the processor 2202, respective process operations are carried out, while the various sorts of programs 2204 are a business I/F selecting program, an I/F analyzing program, a program analyzing program, a preconditional condition seeking program, a dependent relationship analyzing program, a dependent relationship displaying program, and the like.

These programs may be realized in the form of hardware in such a manner that these programs are manufactured as an integrated circuit as processing units for executing respective process operations.

For the sake of simple explanations, respective processing units realized by that the various sorts of programs 2204 are executed by the processor 2203 will be described as a major constitution of the respective processing operations. It should be understood that when the respective process operations are realized by the hardware, the respective processing units perform the respective process operations while these processing units become the major constitution.

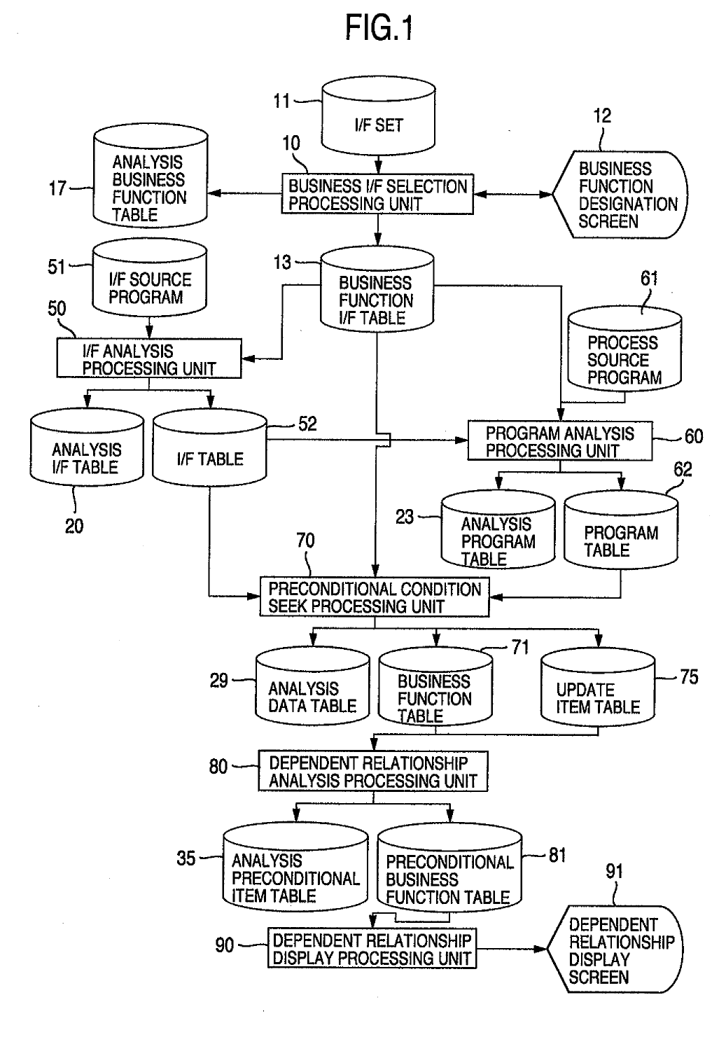

FIG. 1 indicates a functional arrangement in the system of the present embodiment. The system of the present embodiment is arranged by a business I/F selection processing unit 10, an I/F set 11, a screen 12, a business I/F table 13, an I/F source program 51, an I/F analysis processing unit 50, an I/F table 52, a processing source program 61, a program analysis processing unit 60, a program table 62, a preconditional condition seek processing unit 70, a business table 71, a dependent relationship analysis processing unit 80, a preconditonal business function table 81, and a dependent relationship display processing unit 90. The business I/F selection processing unit 10 has a function for accessing an input from a user so as to determine a business function. The I/F set 11 is a set of interfaces employed in a target system. The screen 12 displays thereon the I/F set 11 so as to accept an input from the user. The business I/F table 13 manages a corresponding relationship between the business functions and the I/Fs. The I/F source program 51 is such a set of source programs of I/Fs employed in the target system. The I/F analysis processing unit 50 performs an analysis of an IF. The I/F table 52 manages analysis results of the IFs. The processing source program 61 corresponds to a set of source programs of processing programs employed in the target system. The program analysis processing unit 60 performs an analysis of a program. The program table 62 manages analysis results of the programs. The preconditional condition seek processing unit 70 analyzes a data item to be processed in a business function so as to seek an input source thereof. The business table 71 manages seeking results of the preconditional conditions. The dependent relationship analysis processing unit 80 specifies a dependent relationship between business functions. The preconditional business function table 81 manages results of the dependent relationship analysis. The dependent relationship display processing unit 90 displays thereon the dependent relationships among the business functions which have been acquired by the previous processing operations.

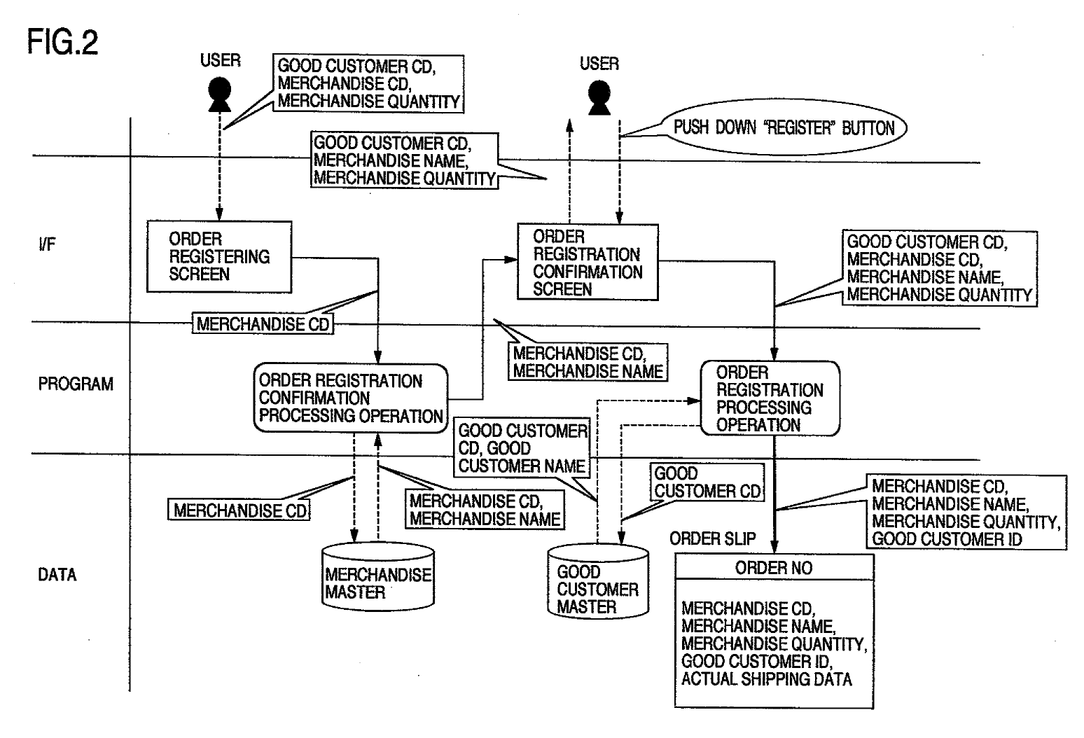

FIG. 2 represents relative characteristics among the I/Fs, the programs, and the data in the present embodiment.

A system to which the present embodiment is directed is arranged by one, or more pieces of interfaces (I/Fs), programs which correspond to the interfaces, and databases (will be referred to “DBs” hereinafter), the contents of which are updated and accessed by the programs.

FIG. 2 represents, as a schematic diagram, inputs/outputs of data in order registration business functions, and process flows as to inputs/outputs of data with respect to these corresponding programs.

A description is made of the process flows as follows:

Firstly, in the present system, an order registration screen is displayed. In response to this displayed order registration screen, the present system accepts a good customer code (CD), a merchandise CD, and a quantity of merchandise, which are entered from a user with respect to the order registration screen. In response to the inputs of the order registration screen, namely, the system calls an order registration confirming process program, while the merchandise CD is employed as an argument among the entered data items. The order registration confirming process program retrieves a merchandise master while the merchandise CD is employed as a key, and assigns a merchandise name corresponding to the merchandise CD as a retrieve result. The order registration confirming process program produces an order registration confirmation screen by conducting the merchandise CD and the merchandise name. “{good customer CD, merchandise name, merchandise quantity}” are represented to the user on the order registration confirming screen. On the order registration screen, an order registering process program is called by depressing a [registration] button by the user, while {good customer CD, merchandise CD, merchandise name, merchandise quantity} are employed as an argument. The order registering process program retrieves a good customer master while the good customer CD is employed as a key, and assigns a name of a good customer corresponding to the good customer CD as a retrieve result. In addition, the order registering process program produces a good customer ID based upon {good customer CD, good customer name}, and automatically produces an order NO (number). The order registering process program updates an order slip record {order NO., merchandise CD, merchandise name, merchandise quantity, good customer ID} is updated, while the order NO. is employed as a key.

In the present embodiment, as previously described, a series of operation flows processed by the user is defined as a business function, and information entered from the user through a set of screens utilized in this business function is mainly employed so as to execute process operations.

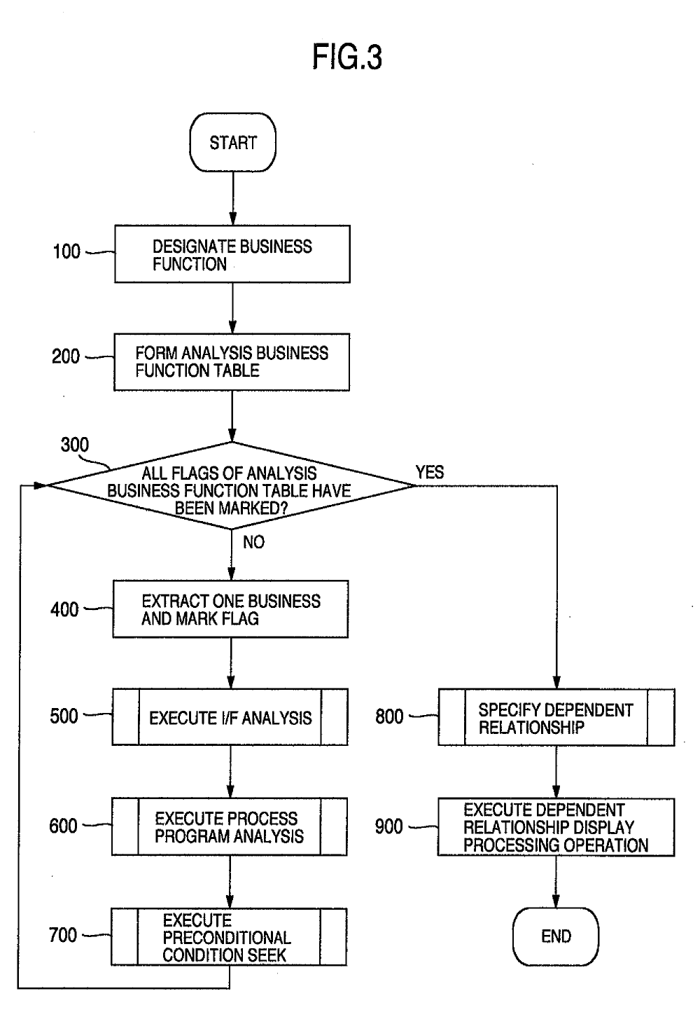

FIG. 3 indicates an entire process flow of the present embodiment. The system displays respective I/Fs which are held by a terget information system, and accepts such a user input that the user uses “which I/Fs in which business function in which sequence based upon the information thereof.” A business I/F selection processing unit produces a business I/F table 13 based upon the information inputted by the user (step 100).

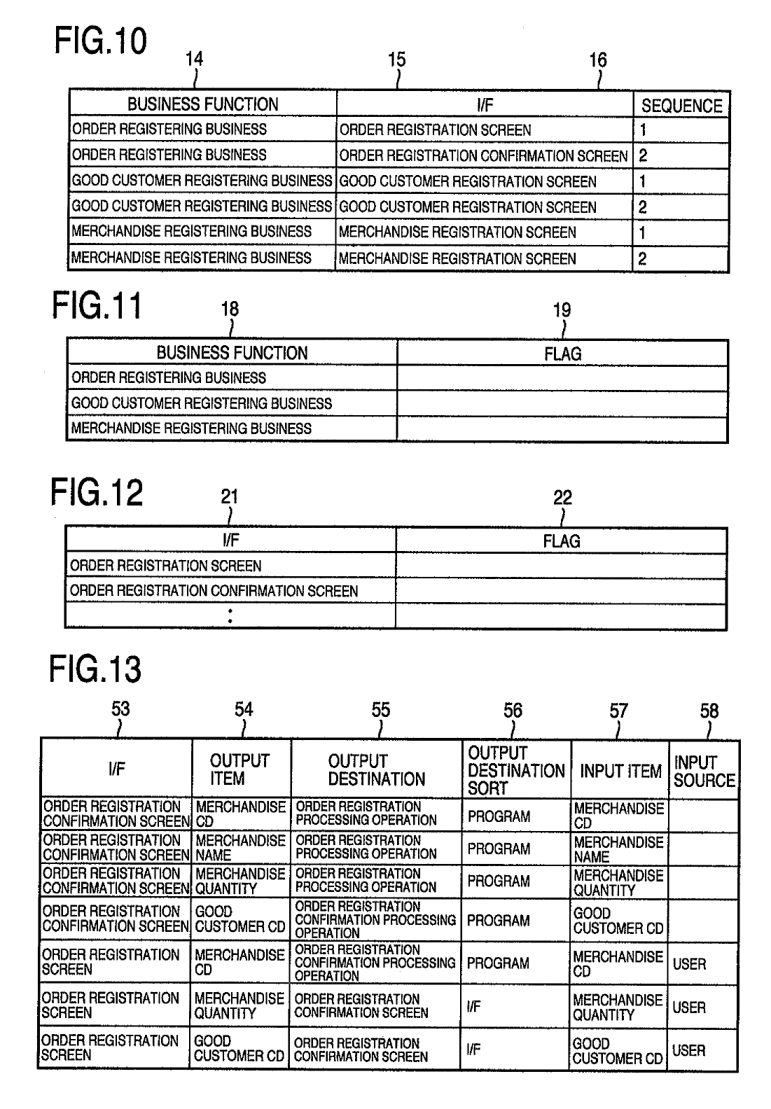

FIG. 10 is a diagram for indicating one example of a business I/F table. The business I/F table 13 has contained a business function1 14, an I/F 15, and sequence 16. The business function 14 stores thereinto names of business functions. The I/F 15 stores thereinto I/F names which are utilized in the business functions indicated in the business function 14. The sequence 16 stores thereinto sequence by which the I/Fs indicated in the I/F 15 are utilized within the business functions represented in the business function 14.

The system displays an input screen of business knowledge (step 100). The system accepts via this input screen such an input that in a certain business function, “which IFs are utilized in which sequence.” For instance, in the order registration business function, in such a case that an order registration screen is firstly used and an order registration confirmation screen is secondly used, such a business function I/F table as represented in FIG. 10 is obtained.

Next, an analysis business table 17 related to the target system is produced based upon the business function I/F table (step 200).

Next, a description is made of an analysis of a target system. The analysis of the target system is carried out with respect to each of the business functions. The analysis business function table 17 manages business functions which should be analyzed.

FIG. 11 is a diagram for showing one example of the analysis business function table for managing the business functions to be analyzed. The analysis business function table contains a business function 18 which stores thereinto names of business functions to be analyzed, and a flag 19 which indicates whether, or not the relevant business function has been analyzed.

Next, the system judges whether or not each of items has been marked by referring to the flag 19 of the analyses business function table 17 (step 300).

In such a case that the respective items have been marked, the system judges that the analyses for the respective business functions as the target have been accomplished, and then, the process operation is advanced to a step 800.

In other cases, the system judges that the analysis has not yet accomplished, and the process operation of the system is advanced to a step 400.

Next, the system reads the analysis business function table by 1 line, extracts a name of a business function stored in the business function 18, and marks the flag 18 (step 400). As the mark with respect to the flag 19, for example, a symbol such as “o” (namely, data formed in accordance with predetermined rule) is recorded.

Next, the I/F analysis processing unit executes an I/F analysis while an I/F contained in the extracted business function is employed as a target (step 500). A result of this I/F analysis is stored in the I/F table 52.

FIG. 13 is a diagram for representing one example as to the I/F table. The I/F table contains an I/F 53, an output item 54, an output destination 55, a sort 56, an input item 57, and an input source 58. The I/F 53 stores thereinto I/F names which should be analyzed. The output items 54 stores thereinto output data items of the I/F 53. The output destination 55 stores thereinto output destinations of the output data items. The sort 56 indicates that an output destination is either a program or an I/F. The input item 57 stores thereinto input data items which constitute sources of the output data items. The input source 58 indicates whether or not an input data item has been inputted form a user.

Next, the program analysis processing unit performs a program analysis while the respective programs corresponding to the I/Fs contained in the derived business function are employed as a target (step 600). A result of this program analysis is stored in the program table 62.

FIG. 15 is a diagram for showing one example of the program table. The program table contains a program 63, an output item 64, an output destination 65, a sort 66, an input item 67, and an input source 68. The program 63 stores thereinto a name of such a program which should be analyzed. The output item 64 stores thereinto an output data item of the relevant program. The output destination 65 stores thereinto an output destination of the relevant output data item. The sort 66 indicates whether the relevant output destination is an I/F, or a DB. The input item 67 stores thereinto a data item based upon the relevant output data item. The input source 68 indicates whether or not the relevant input data item has been acquired for the DB.

Next, the preconditional condition seek processing unit performs a preconditional condition seeking operation, while the respective data items are employed as a target, which are updated with respect to the DB within the derived business function (step 700). A result of this preconditonal condition seeking operation is stored in the business function table 71.

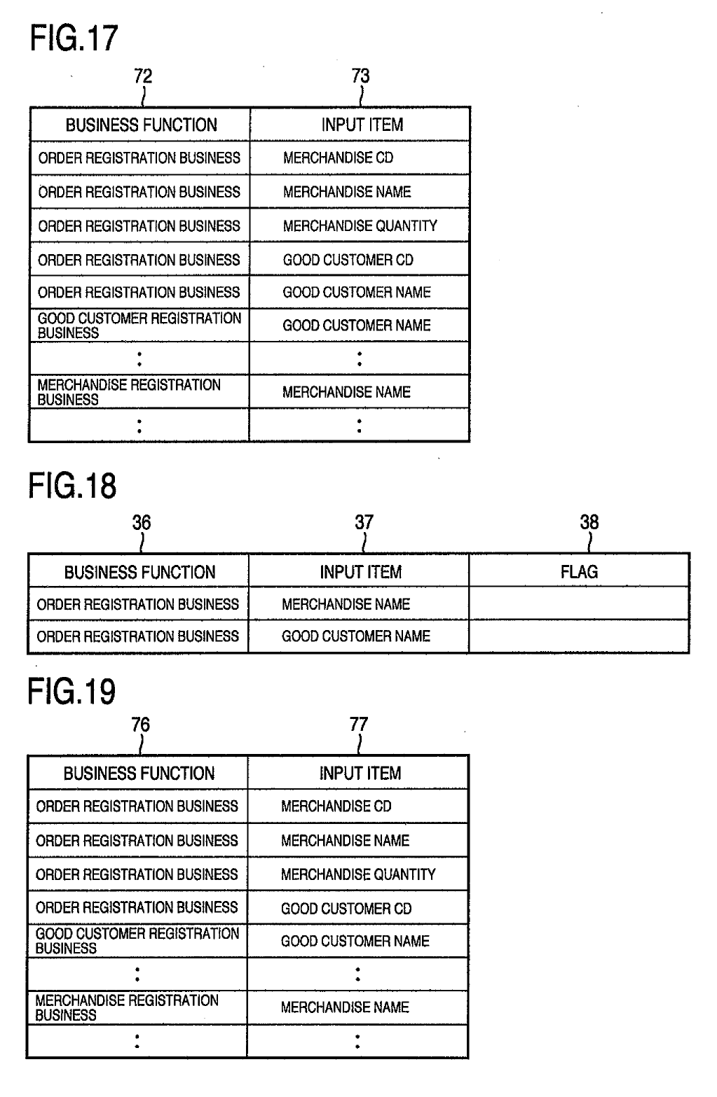

FIG. 17 is a diagram for showing one example of the business function table. The business function table contains a business function 72, and an item 73. The business function 72 stores thereinto names of business functions to which data items to be analyzed belong. The item 73 stores thereinto input items corresponding to preconditional conditions within the business functions.

In this case, the expression “corresponding to preconditional conditions” implies such data items which are updated within a certain business function, or data items which constitute the data items to be updated, but such a data item which has not yet been entered from a user within this business function.

When the judgement result made in the step 300 is given as such a case where the respective items as to the flag 19 of the analysis business function table 17 have already been marked, the dependent relationship analysis processing unit specifies a dependent relationship with respect to the respective business functions contained in the target system (step 800). A result obtained by this dependent relationship specifying process is stored in the preconditional business function table 81.

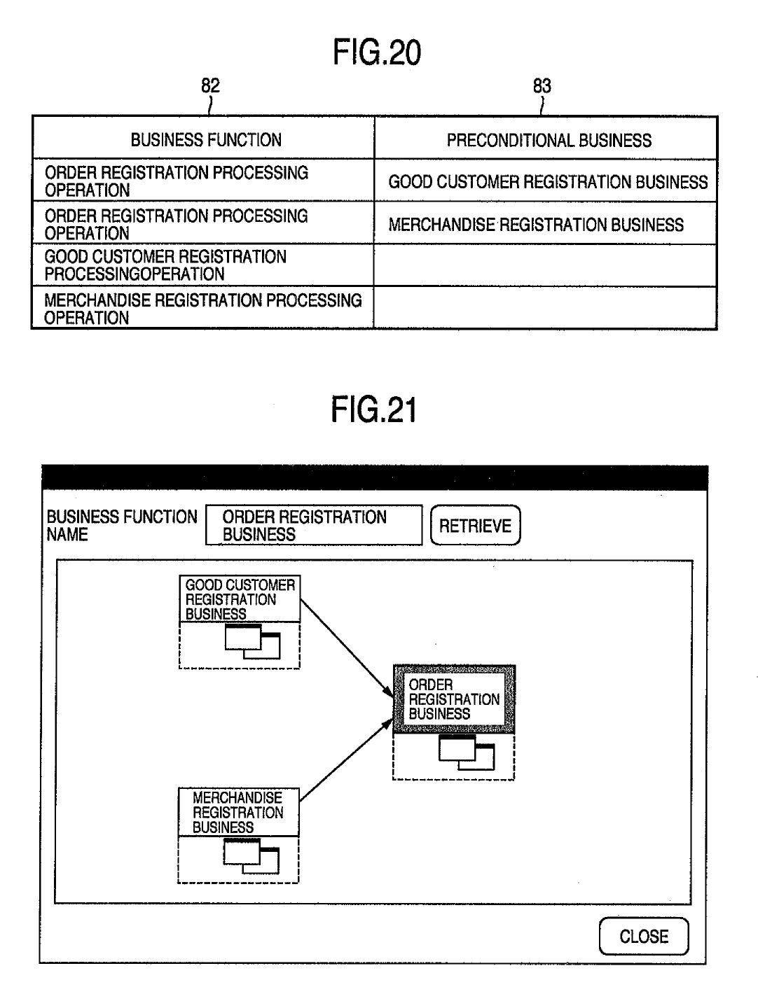

FIG. 20 is a diagram for indicating one example of the preconditional business function table. The preconditional business function table contains a business function 82 and a preconditional business 83. The business function 82 stores thereinto names of business functions which should be analyzed. The preconditional business 83 stores thereinto business function names of the preconditional business functions.

In this case, the expression “corresponding to preconditional business function” indicates such a business function which has as an input item; a data item corresponding to a preconditional condition of a certain business function.

Finally, the dependent relationship display processing unit 90 performs a display process operation, while each of the business functions is employed as a target, which belongs to the target system. As a result, the system can provide a business specification to the user (step 900).

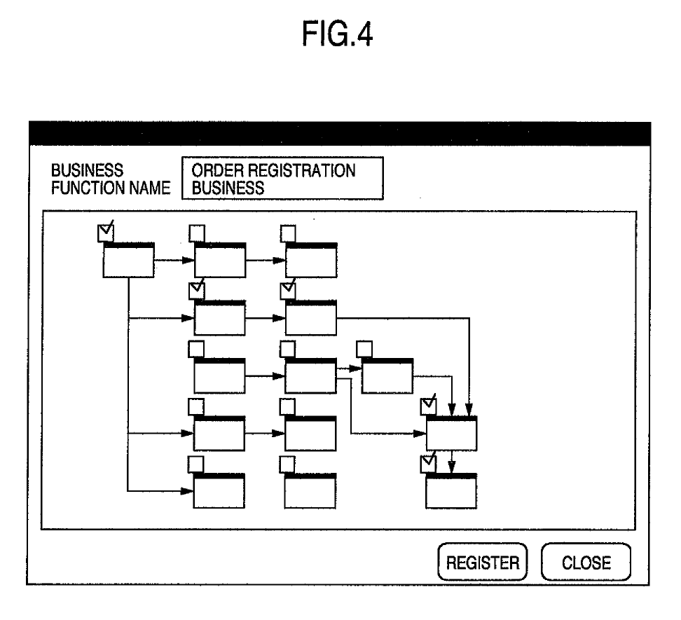

Next, a detailed description is made of the process operation in the step 100. FIG. 4 is one example as to a screen image displayed in the step 100. In the step 100, the business I/F selection processing unit derives I/Fs (interfaces) from the I/F set 11, and displays a relationship among the I/Fs, for instance, transition information. In response to this representation, the system specifies a name of a business function, which is designated with respect to the screen displayed from the user. In the system, for example, inputting of the business function name is accepted by a text field, and the like. Next, the system accepts a selection of the I/Fs utilized in this business function, and inputting of sequence for utilizing these I/Fs. For instance, the system accepts the inputting operation by check boxes related to the I/Fs under display. When a business function name is inputted an I/F to be utilized is selected, and utilization sequence is inputted, if each of these items may be designated with respect to a single business function, then any methods may be employed. Thus, no severe method is required.

For example, in such a case that the order registration screen is firstly utilized and the order registration confirmation screen is secondly utilized in the order registration business, such a business I/F table as shown in FIG. 10 is formed.

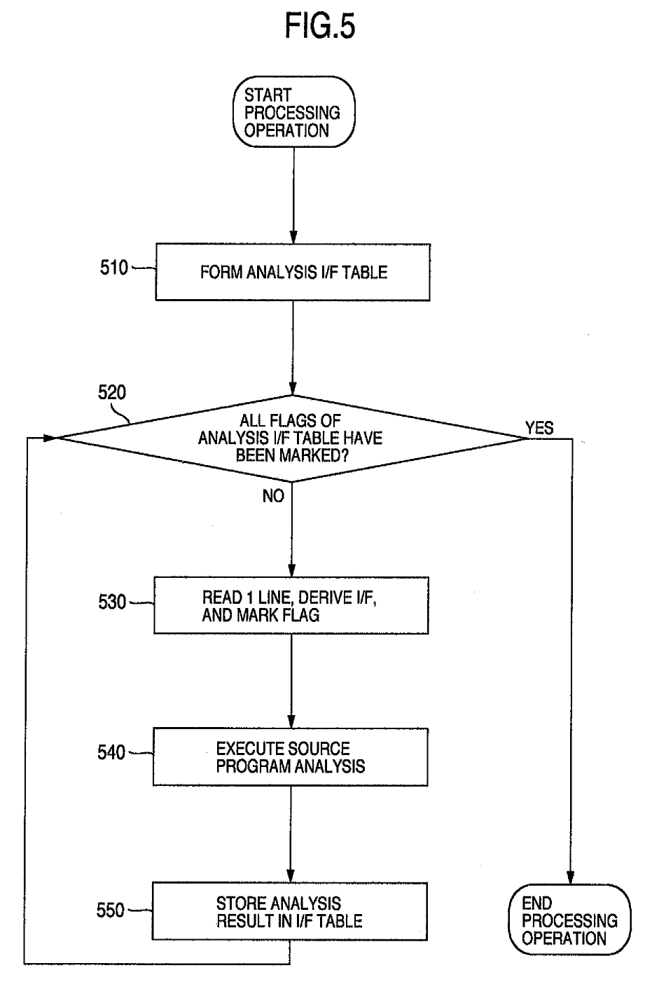

Next, a detailed description is made of the process operation of the step 500 with reference to FIG. 5.

FIG. 5 is a diagram for indicating a detailed process flow of an I/F analysis.

While the business function name derived in the step 400 is employed as a key, the I/F analysis processing unit seeks the business function 14 of the business function I/F table 13, extracts an I/F stored in the I/F 21 in the relevant line, and transfers (records) the content of this extracted I/F to an analysis I/F table (step 510).

FIG. 12 is a diagram for showing one example as to the analysis I/F table in such a case that [order registration business function] is employed as a key. The analysis I/F table contains an I/F 21 and a flag 22. The I/F 21 stores thereinto I/F names which should be analyzed. The flag 22 indicates whether or not this I/F has been analyzed.

The I/F analysis processing unit seeks the flag 22 of the analysis I/F table so as to judge whether or not each of the items has been market (step 520).

When the respective items have already been marked, the I/F analysis processing unit judges that the analyzing operations of the respective I/Fs have already been accomplished, the system accomplishes process operations of the step 500.

In other cases, the I/F analysis processing unit judges that the analyzing operations have not yet been accomplished, and then the process operation is advanced to a step 530.

Next, the I/F analysis processing unit reads one line in which the flag 22 of the analysis I/F table is not blank, derives an I/F name stored in the I/F 21 of the relevant line, and then, marks the flag 22 of the relevant line (step 530). As the mark with respect to the flag 22, for instance, such a symbol of “o” is recorded.

Then, while the derived I/F name is employed as a key, the I/F analysis processing unit derives a relevant I/F from the I/F source program so as to analyze this derived I/F. In the I/F analysis process operation, the I/F analysis processing unit outputs an output item, an output destination, a sort, an input item, and an input source as an analysis result. The output item indicates that the analyzed I/F outputs which data. The output destination indicates that this output item is outputted with respect to which program, or which I/F. The sort indicates that this output destination corresponds to either a program or an I/F. The input item represents that the output item is produced from which input item. The input source indicates that this input item is inputted from which unit.

The analysis result of the I/F is stored in the I/F table 52.

For example, assuming now that one example of an I/F is a screen, in such a case that there are such items displayed on this screen, it is so assumed that the output destination 55 is blank, and an expression “user” is written in the sort 56.

Also, as to such a data item which is clearly inputted from the user with respect to the I/F, for instance, a test input on the screen, the expression “user” is written in the input source 58, whereas as to any other data items, the input source 58 is blank.

For example, when the following case can be understood that the I/F to be analyzed is [order registration confirmation screen], and as a result of analysis, [merchandise name] is equal to the item to be displayed on the screen, such a single line constructed of {order registration confirmation screen, merchandise name, “ ”, user, merchandise name, “ ”} is written in the I/F table.

FIG. 13 indicates one example in such an analyzed result has been stored that while [order registration confirmation screen] and [order registering screen] are employed as a key respectively, I/F analyses have been carried out.

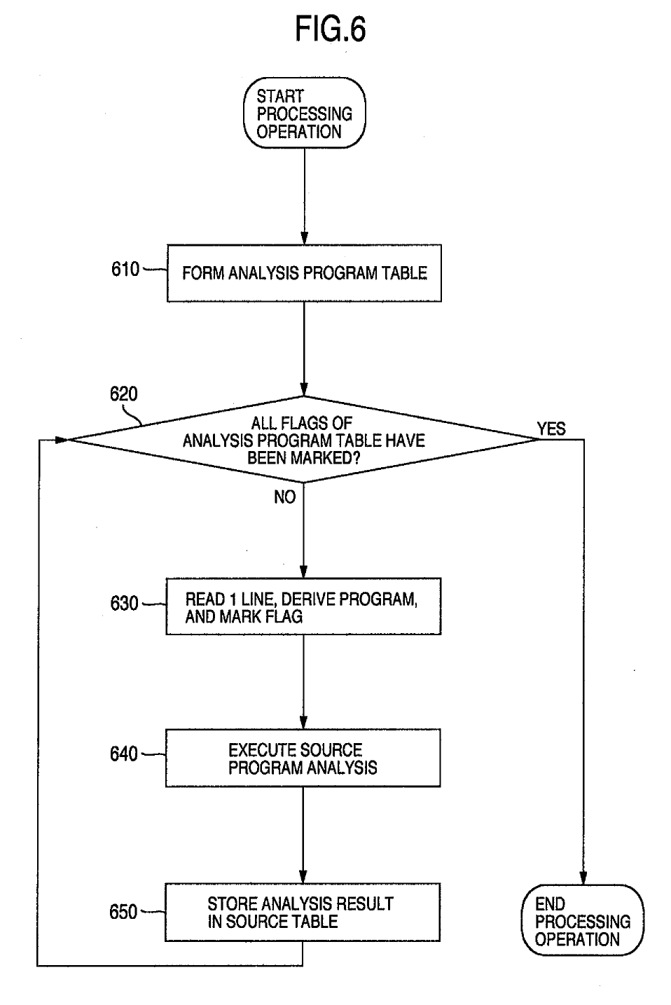

Next, a detailed description is made of the process operations of the step 600 with reference to FIG. 6.

FIG. 6 is a diagram for indicating a detailed process flow of a program analysis.

The program analysis processing unit seeks such an item that the sort 56 of the I/F table 52 produced in the step 500 is “program”, extracts both the I/F 53 and the output destination 55 of the relevant line, deletes the duplicated items, and then, stores the extracted I/F 53 and output destination 55 in the I/F 24 and the program 25 of the analysis program table 23, respectively.

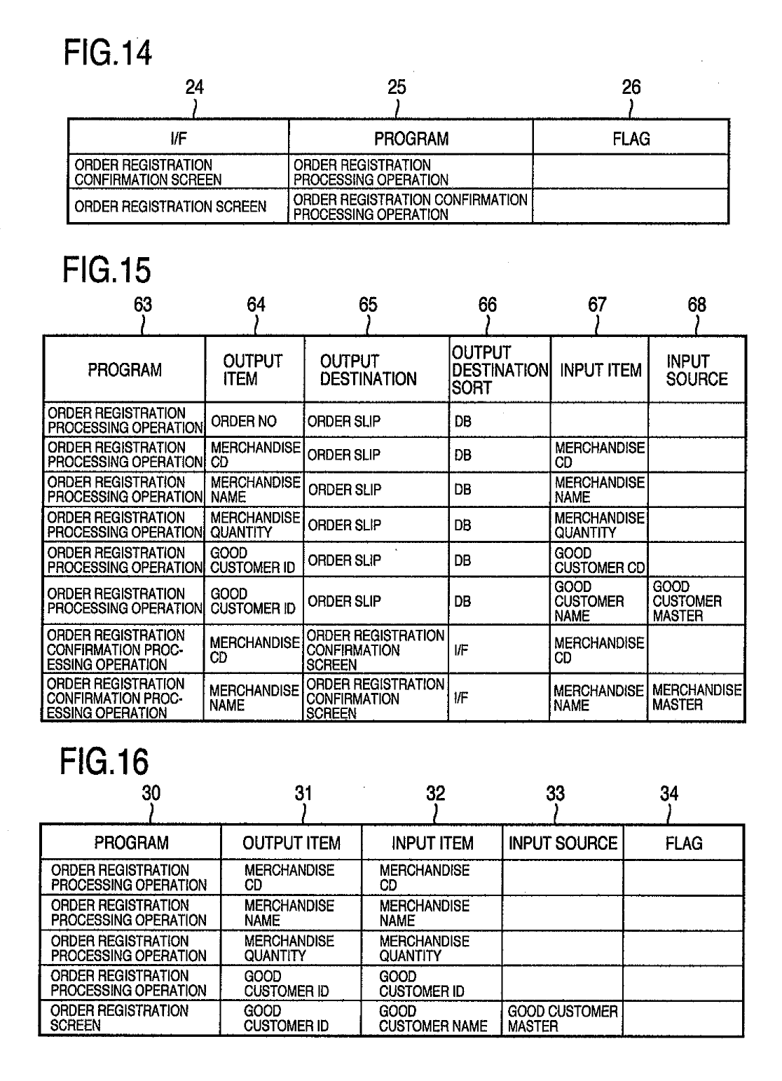

FIG. 14 is a diagram for showing one example of an analysis program table produced in such a case that the I/F table shown in FIG. 13 is employed as an input. The analysis program table contains an I/F 24, a program 25, and a flag 26. The I/F 24 stores thereinto an I/F name corresponding to a program which should be analyzed. The program 25 stores thereinto a name of a program which should be analyzed. The flag 26 indicates whether or not the relevant program has been analyzed.

The program analysis processing unit seeks the flag 26 of the analysis program table 26 so as to judge whether or not each of the items has been marked (step 620).

In such a case that the respective items have been marked, the program analysis processing unit judges that analyzing operations for the respective programs to be analyzed have been accomplished, and then, accomplishes the process operation of the step 600.

In other cases, the program analysis processing unit judges that the analyzing operations have not yet been accomplished, ant then, the process operation is advanced to a step 630.

Next, the program analysis processing unit reads the produced analysis program table 23 by 1 line, derives a program name stored in the relevant line of the program 25, and then, marks the flag of the relevant line (step 630).

While the derived program name is employed as a key, the program analysis processing unit derives a relevant program from the process source program, and analyzes the derived program.

The program analysis processing unit stores an analysis result of the program in the program table 62.

As to items which refer to the DB among the input data items with respect to the program to be analyzed, the corresponding DB name is written in the input source 68, whereas as to other items, the input source 68 is blank.

For instance, when the following items can be grasped, namely, the program to be analyzed is [order registering process], and as a result of the analysis, [good customer ID] is such a data produced from two input items of [good customer CD] and [good customer name], two lines of {order registering process, good customer ID, order slip, DB, good customer CD, “ ”} and {order registering process, good customer ID, order slip, DB, good customer name, good customer master} are recorded in the program table.

FIG. 15 is one example of the program table in which such a result has been stored that the program analysis was carried out, while [order registering process] and [order registration confirming process] were employed as keys, respectively.

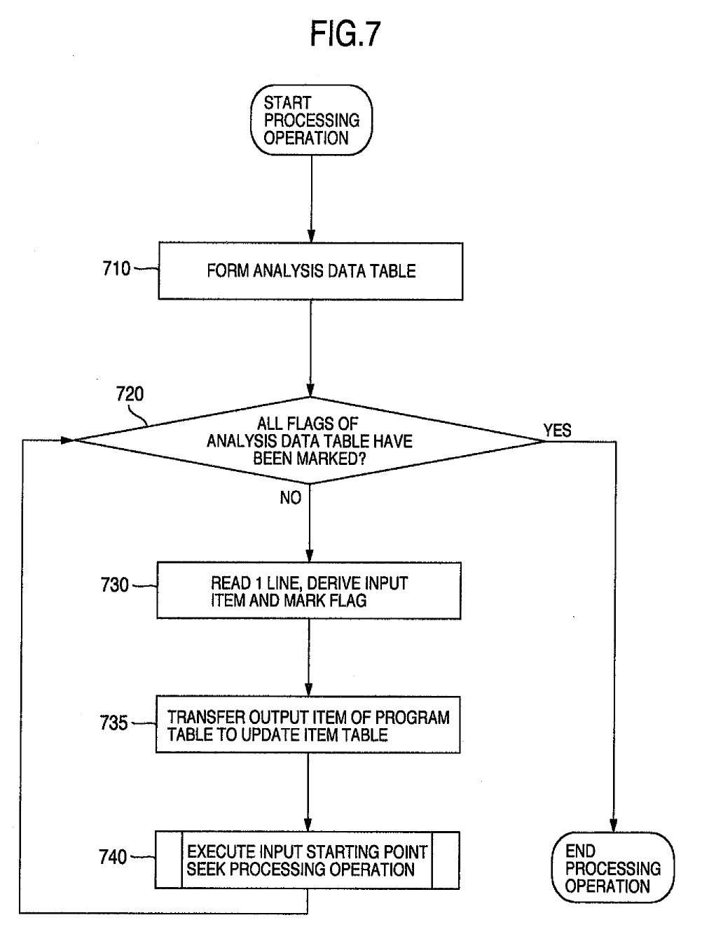

Next, a detailed description is made of the process operation executed in the step 700 with reference to FIG. 7.

The preconditional condition seek processing unit seeks such an analyzed data item that the sort 66 of the program table 62 produced in the step 600 is “DB” and the input item 67 thereof is not blank, and extracts the relevant line so as to form an analysis data table (step 710).

A processing purpose of the above-described step 700 is to analyze a data item which is updated with respect to the DB within the relevant business function so as to specify an input source of this analyzed data item. It is possible to judge that the data item which has been stored in the output item 64 of such a line that the input item 67 is blank in the program table 62 corresponds to such a data item which has been originally produced within the program corresponding to the program name which has been stored in the program 63 of the relevant line, this data item is not included in the analysis data table.

FIG. 16 shows one example of the analysis data table. As shown in FIG. 16, the analysis data table 29 contains a program 30, an output item 31, an input item 32, an input source 33, and a flag 34. The program 30 stores thereinto program names to which data items to be analyzed belong. The output item 31 stores thereinto the data items which should be analyzed. The input item 32 stores thereinto data items which constitute bases of the data items. The input source 33 stores thereinto input sources of the above-described input items. The flag 34 judges whether or not the data items have been analyzed.

Next, the preconditional condition seek processing unit seeks the flag 34 of the analysis data table 29 in order to judge whether or not the respective items have been marked (step 720).

In such a case that the respective items have been marked, the preconditional condition seek processing unit judges that the analyses as to the data items to be analyzed have been accomplished, and then, accomplishes the process operation of the step 700.

In other cases, the preconditional condition seek processing unit judges that the analysis has not yet been accomplished, and then, the process operation is advanced to a step 730.

Next, the preconditional condition seek processing unit reads one line of the analysis data table 29 in which the flag 34 is blank, extracts such a data item stored in the input item 32 of the relevant line, and marks the flag 34 of this line (step 730). The preconditional condition seek processing unit inputs a symbol such as “o” as the mark for the flag 34.

Next, the preconditional condition seek processing unit transfers both the relevant business function name and the output item 31 of this line to the business function 76 and the output item 77 of the update item table 75 (step 735).

FIG. 19 is a diagram for indicating one example of an update item table. As shown in FIG. 19, the update item table contains a business function 76 and an output item 77. The business function 76 stores thereinto names of business functions to be updated. The output term 76 stores thereinto data items which are updated with respect to the DB within this business function.

Next, the preconditional condition seek processing unit performs an input starting point seeking process operation while such a data item stored in the input item 32 of the relevant line is employed as a target (step 740).

The above-described input starting point seeking process operation implies the below-mentioned seeking process operation: That is, the preconditional condition seek processing unit specifies that an output term contained in a certain program, or a certain I/F has been produced based upon which input item within the certain program, or the certain I/F; seeks such a program, or an I/F, which may output the specific input term; replaces the above-described process while this input term is employed as an output item in the above-described program, or I/F, so that the output term to which the attention was firstly paid has been inputted in which form within the target business function.

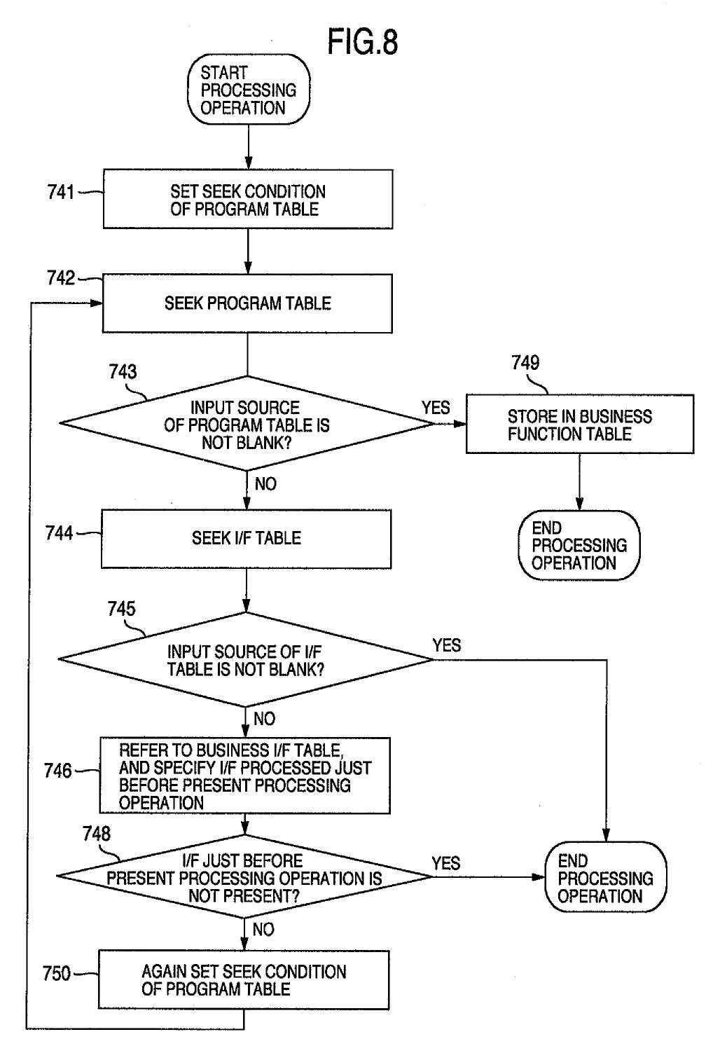

FIG. 8 is a diagram for describing a detailed content of the input starting point seeking process operation.

As a result of the input starting point seeking process operation, the relevant business function is stored in the business function 72 of the business function table 71, and such a data item judged that the data item to be searched is not inputted within this business function is stored in the input terminal 73 of the business function table 71.

FIG. 17 is one example for indicating such a result that while [order registration business function] is employed as a target to be analyzed, data items which constitute a base of a DB item to be updated with the relevant business function are given as {merchandise CD, merchandise name, merchandise quantity, good customer CD, good customer name}; among these data items, such a data item is {merchandise name, good customer name}, which is so judged that these data items are not inputted within the order registration business function, as a result of the input starting point seeking process operation.

Next, a detailed description is made of the input starting point seeking process operation (step 740) based upon the flow chart of FIG. 8.

In the step 740, one line of the analysis data table read in the step 730 is inputted.

While the program stored in this line of the program 30, the data item stored in the output item 31, and the data item stored in the input item 32 are employed as a key, the program 63, the output item 64, and the input item 67 of the program table 62 of the program table 62 are defined as a seek condition with respect to the program table; and seek targets are defined as the program 63, the output item 64, and the input item 67 of the program table 62, respectively (step 741).

The preconditional condition seek processing unit seeks the program table as to the seek condition and the seek targets set in either the step 742 or the step 750, and derives the relevant line (step 742).

Next, the preconditional condition seek processing unit reads the extracted line so as to judge whether or not the input source 68 of this relevant line is blank (step 743).

In such a case that the input source 68 is not blank, the preconditional condition seek processing unit judges that the input source of the noticed data item is the “DB”, and the process operation is advanced to a step 749.

In such a case that the input source 68 is blank, the preconditional condition seek processing unit judges that the input source of the noticed data item is an input source outside the program.

For instance, in such a case that the noticed data is [merchandise CD], since the input source thereof is blank as indicated in the program table, the preconditional condition seek processing unit judges that [merchandise CD] corresponds to such a data which is entered outside the program order registration processing operation.

Next, while the program stored in the relevant line of the program 63 and the data item stored in the input item 67 are employed as a key, the preconditional condition seek processing unit seeks the output item 54 and the output destination 55 of the I/F table 52 so as to extract corresponding lines (step 744).

Next, the preconditional condition seek processing unit reads one line of the extracted lines so as to judge whether or not the input source 58 is blank (step 745).

In such a case that the input source 58 is not blank, the preconditional condition seek processing unit judges that the input source of the noticed data item is the user, and the data item thereof is such a data inputted in this business function, and thus, accomplishes the process operation of the step 740.

In such a case that the input source 58 is blank, the preconditional condition seek processing unit judges that the input source of the noticed data item is any other source than the user.

For instance, in such a case that the noticed data is [merchandise CD], since the corresponding input source is blank, the preconditional condition seek processing unit judges that [merchandise CD] is such a data entered from any other source than the user.

Next, while an I/F stored in the I/F 53 of the relevant line in the I/F table 52 is employed as a key, the preconditional condition seek processing unit seeks the I/F 15 of the business I/F table 13 and derives a numeral value stored in the sequence 16 of the relevant line. Moreover, while a normal value corresponding to (its numeral value −1) is employed as a key, the preconditional condition seek processing unit seeks the sequence 16 of the business I/F table 13 (step 746). As a consequence, the preconditional condition seek processing unit can seek the I/F which is processed just before the present process operation.

For example, in such a case that the I/F noticed in the step 744 is the order registration confirmation screen, while this I/F is employed as a key, the preconditional condition seek processing unit seeks the business I/F table, so that the order registering screen is specified as the I/F which is processed just before the present process operation.

When the relevant line is not present, the preconditional condition seek processing unit judges that the seeking operations related to the respective data items stored in the output item 32 of the analysis data table 29 have been accomplished, and thus, accomplishes the process operation of the step 740.

When the corresponding line is present, while the I/F 15 of the analysis business table 13 is employed as a key, the preconditional condition seek processing unit seeks the analysis program table 23 and derives a program stored in the relevant line of the program 25. While the derived program and a data item stored in the input item 57 of the line of the I/F table 52 in the step 744 are defined as a seek condition with respect to the program table, the seek targets are the program 63 and the output item 64 of the program table 62, and then the process operation is returned to the step 742.

Finally, the business function name which has been stored in the business function 18 of the target analysis business function table 17, and the data item which has been stored in the input item 67 of the program table 62 are recorded in the business function 72 and the input item 73 of the business function table 71, respectively.

Since the above-described process operations are carried out, the preconditional condition seek processing unit can specify that both the data item updated in the relevant business function in the business function unit and the updated data item have been produced based upon which input data item, and can specify where the generation source of this input data is located, and also, can produce the data item determined by this business function, and the information of the data item having such a preconditional condition that the data must be inputted from other business functions.

In the present embodiment, at the stage of this process operation, the correspondence relationship between the business functions and the interfaces and the correspondence relationship between the interfaces and the programs are searched as the data item key.

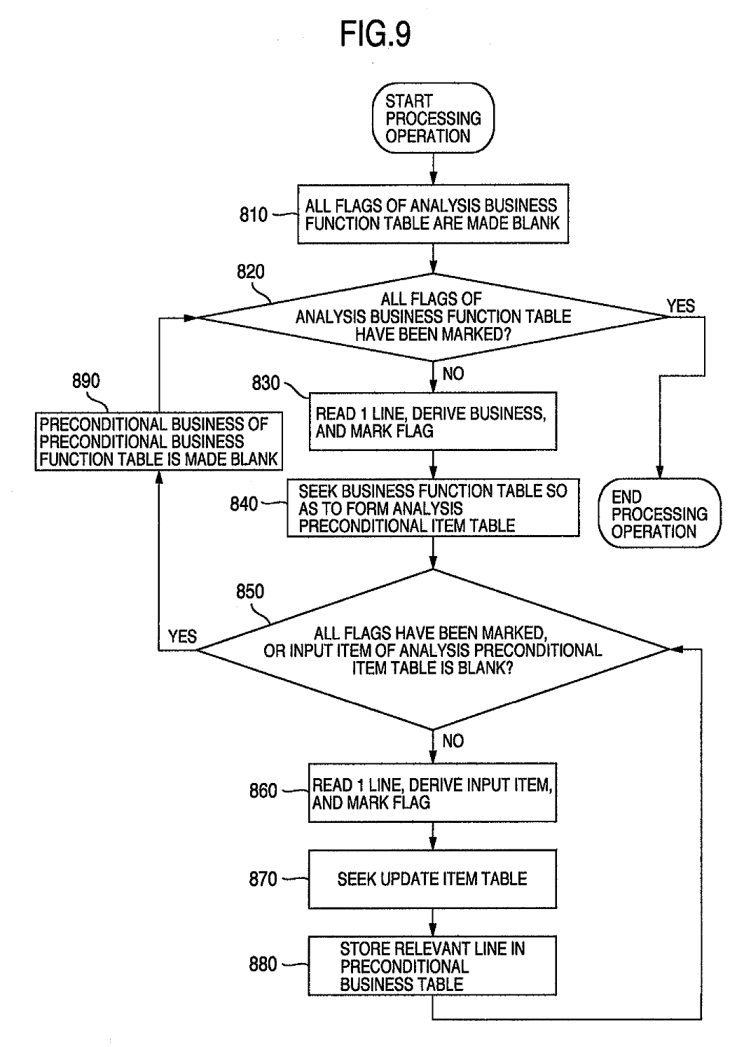

Next, a detailed description is made of the step 800 with reference to FIG. 9.

FIG. 9 is a diagram for describing detailed process flow operations as to a dependent relationship analysis.

In the step 800, the dependent relationship analysis processing unit inputs thereinto the above-described business function formed in the step 700, specifies such a business function for updating the data item which has been stored in the input item 73, and forms a preconditional business function table 81.

FIG. 20 shows one example of the preconditional business function table. As indicated in FIG. 20, the preconditional business function table contains a business function 82 and preconditional business 83. The business function 82 stores thereinto noticed business function names. The preconditional business 83 stores thereinto names of business functions which constitute the preconditional conditions.

The columns of the flag 19 of the analysis business function table 17 formed in the step 100 are made blank respectively (step 810).

Next, the dependent relationship analysis processing unit retrieves the flag 19 of the analysis business function table 17, and judges whether or not the respective items thereof have already been marked (step 820).

In such a case that the respective items have already been marked, the dependent relationship analysis processing unit judges that analyzing operations for all of the business functions to be analyzed have been accomplished, and then, accomplishes the process operations of the step 800.

In other cases, the dependent relationship analysis processing unit judges that the analyzing operations have not yet been accomplished, and then, the process operation is advanced to a step 830.

Next, the dependent relationship analysis processing unit reads one line of the analysis business table 17, derives a business function name stored in the business function 18, and marks the flag 19 (step 830). As the mark with respect to the flag 19, for example, such a symbol as “o” is recorded.

While the derived business function name is employed as a key, the dependent relationship analysis processing unit seeks the business 72 of the business table 71; derives both a business function name which has been stored in the business function 72 of the relevant line and a data item which has been stored in the item 73 thereof; and transfers the derived business function name and the derived data item to the business function 36 and the input item 37 of the analysis preconditional item table 35 so as to form the analysis preconditional item table 35 (step 840).

FIG. 18 is a diagram for showing one example as to the analysis preconditional item table. As indicated in FIG. 18, the analysis preconditional item table 35 contains the business function 36, the input item 37, and the flag 38. The business function 36 stores thereinto the business function names to which the data item to be analyzed belongs. The input item 37 stores thereinto the data item to be analyzed. The flag 38 indicates whether or not the data item has been analyzed.

Next, the dependent relationship analysis processing unit refers to the flag 38 of the analysis preconditional item table 35 so as to judge whether or not the respective items have been marked (step 850).

In such a case that the respective items have been marked, the dependent relationship analysis processing unit judges that the analyzing operations have been accomplished, and then, the process operation is advanced to a step 890.

In other cases, the dependent relationship analysis processing unit judges that the analyzing operations have not yet been accomplished, and then, the process operation is advanced to a step 850.

Next, the dependent relationship analysis processing unit reads one line from such lines that the flag 38 of the analysis preconditional item table 35 is blank, and marks the flag 38 (step 850). As the mark with respect to the flag 38, for instance, such a symbol as “o” is recorded.

The dependent relationship analysis processing unit derives a business function name stored in the business function 36 of this read line.

While the input item stored in the item 37 of the relevant line is employed as a key, the dependent relationship analysis processing unit seeks the output 77 of the update item table 75 (step 870).

In such a case that the relevant line is present, the dependent relationship analysis processing unit stores the business function name derived from the business function 36, and also, stores the business function name stored in the business function 76 of the relevant line into the business function 82 and the preconditional business 83 of the preconditional business function table 81 (step 880).

For instance, with respect to {order registration business}, based upon the analysis preconditional item table shown in FIG. 18, such items that [order registration business] defines as the preconditional condition are [merchandise name] and [good customer]; while these items are employed as a key, the dependent relationship analysis processing unit seeks the output item 77 of the update item table 75, so that two business functions are obtained, namely [merchandise business] and [good customer registration business] are obtained. In the preconditional business function table 81, two lines of {order registration business, merchandise registration business} and {order registration business, good customer registration business} are additionally employed.

Next, in the step 900, the dependent relationship display processing unit inputs thereinto the preconditional business function table 81, and draws a dependent relationship among the business functions by employing rectangular shapes and arrows in order to represent the dependent relationship among the business functions.

For example, the dependent relationship display unit draws rectangular shapes indicative of [good customer registration business function], [merchandise registration business function], and [order registration business function], and draw arrows from two pieces of the former functions to one piece of the latter function, and then, displays the resultant drawing to the user.

FIG. 21 indicates one example as to a screen which is displayed as an output of the system according to the present embodiment. The output result of the system according to the present embodiment illustratively indicates a dependent relationship among business functions. For example, a user inputs a noticed business function name, and pushes a retrieve button, so that such business functions are displayed which have the dependent relationship with the business functions. When a business function is displayed, if a relationship between this business function and an I/F which is utilized by the user is made clear, then information judged by the system is also displayed. For instance, I/F images which are utilized by the user are displayed under rectangular shapes indicative of the business functions.

Since such a representation is made the user can readily comprehend the relationship between the processing images which are made in the normal business, and the business specifications extracted from the information system.

It should be further understood by those skilled in the art that although the foregoing description has been made on embodiments of the invention, the invention is not limited thereto and various changes and modifications may be made without departing from the spirit of the invention and the scope of the appended claims.

1. A business specification comprehension assistance system for assisting comprehension of a business specification of a business system in which a plurality of business are related to each other and each of the business has one, or a plurality of interfaces, comprising:
a business interface selection processing unit for accepting information related to business and information related to one, or a plurality of interfaces used in said business;
an interface analysis processing unit for analyzing said accepted interface so as to extract a program used in said interface;
a program analysis processing unit for analyzing said extracted program, for extracting a data item outputted to a storage apparatus and whose data has been updated among data items outputted by said program, and for storing said extracted data item in the storage apparatus in correspondence to said business;
a preconditional condition seek processing unit for judging whether or not said updated data item corresponds to such a data item which is accepted by an interface within said business, and for specifying said data item as a preconditional condition item in such a case that as a result of said judgement, said updated data item is not equal to the data item which is accepted by the interface within the business;
a dependent relationship analysis processing unit operated in such a manner that when said preconditional condition item is present within the data items to be updated, which have been stored in correspondence with said respective business, such a business for updating said stored data item to be updated is specified as preconditional business; and
a dependent relationship display processing unit for outputting such a message that said preconditional business is business which proceeds to said business.

2. A business specification comprehension assistance system as claimed in claim 1 wherein:
said business interface selection processing unit stores the information related to said accepted interface in the storage apparatus every information related to the corresponding business; and
said interface analysis processing unit analyzes said interface every said business.

3. A business specification comprehension assistance system as claimed in claim 2 wherein:
said preconditional condition seek processing unit judges whether or not each of the data items outputted by said interface with respect to said program corresponds to a data item which is accepted as an input by the interface within said business based upon information capable of identifying whether said data item is input data from a user, or data outputted from another program within the business system with respect to the interface.

4. A business specification comprehension assistance system as claimed in claim 1 wherein:
said program analysis processing unit extracts a data item in which a predetermined flag has not been recorded when said data item is extracted.

5. A business specification comprehension assistance system as claimed in claim 4 wherein:
said program analysis processing unit records said extracted data item in correspondence with said flag.

6. A business specification comprehension assistance system as claimed in claim 5 wherein:
said program analysis processing unit employs a predetermined symbol as said flag.

7. A business specification comprehension assistance method for assisting comprehension of a business specification of a business method in which a plurality of business are related to each other and each of the business has one, or a plurality of interfaces, comprising:
a step in which a business interface selection processing unit accepts information related to business and information related to one, or a plurality of interfaces used in said business;
a step in which an interface analysis processing unit analyzes said accepted interface so as to extract a program used in said interface;
a step in which a program analysis processing unit analyzes said extracted program, extracts a data item outputted to a storage apparatus and whose data has been updated among data items outputted by said program, and stores said extracted data item in the storage apparatus in correspondence to said business;
a step in which a preconditional condition seek processing unit judges whether or not said updated data item corresponds to such a data item which is accepted by an interface within said business, and specifies said data item as a preconditional condition item in such a case that as a result of said judgement, said updated data item is not equal to the data item which is accepted by the interface within the business;
a step in which when said preconditional condition item is present within the data items to be updated, which have been stored in correspondence with said respective business, a dependent relationship analysis processing unit specifies such a business for updating said stored data item to be updated as preconditional business; and
a step in which a dependent relationship display processing unit outputs such a message that said preconditional business is business which proceeds to said business.

8. A business specification comprehension assistance method as claimed in claim 7 wherein:
said business interface selection processing unit stores the information related to said accepted interface in the storage apparatus every information related to the corresponding business; and
said interface analysis processing unit analyzes said interface every said business.

9. A business specification comprehension assistance method as claimed in claim 8 wherein:
said preconditional condition seek processing unit judges whether or not each of the data items outputted by said interface with respect to said program corresponds to a data item which is accepted as an input by the interface within said business based upon information capable of identifying whether said data item is input data from a user, or data outputted from another program within the business system with respect to the interface.

10. A business specification comprehension assistance method as claimed in claim 7 wherein:
said program analysis processing unit extracts a data item in which a predetermined flag has not been recorded when said data item is extracted.

11. A business specification comprehension assistance method as claimed in claim 10 wherein:
said program analysis processing unit records said extracted data item in correspondence with said flag.

12. A business specification comprehension assistance method as claimed in claim 11 wherein:
said program analysis processing unit employs a predetermined symbol as said flag.
